(19) United States
(12) Patent Application Publication
(10) Pub. No.: US 2008/0180208 A1
(43) Pub. Date: Jul. 31, 2008

(54) Fuse Sleeve Having Window for Blown Fuse Indication

(75) Inventor: Larry Siebens, Asbury, NJ (US)

Correspondence Address: HOFFMANN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 11/971,251

(22) Filed: Jan. 9, 2008

Related U.S. Application Data
(60) Provisional application No. 60/898,238, filed on Jan. 30, 2007.

(51) Int. Cl. H01H 85/30

(52) U.S. Cl. 337/241

(57) ABSTRACT

A protective sleeve for a fuse connection includes an insulative sleeve body having first and second body portions adapted to provide a water-resistant seal at opposite ends of the fuse connection and a substantially transparent window disposed between the first and second body portions. The window permits a visual indicator of the fuse of the fuse connection to be visible therethrough.

### CROSS-REFERENCE TO RELATED APPLICATIONS

This application claims the benefit of U.S. Provisional Application No. 60/898,238, filed on Jan. 30, 2007, which is incorporated by reference herein in its entirety for all purposes.

### BACKGROUND OF THE INVENTION

The present invention relates to electrical cable junctions for power distribution systems, and more particularly to a fuse junction sleeve for providing visual indication of the status of the fuse.

A fuse is a protective device for electrical circuits which has a fusible element that melts and opens to interrupt the circuit when subjected to excessive currents. The melting occurs, in large part, due to i²R heating of the fusible element.

Fuses come in numerous designs and arrangements to provide appropriate system protection and coordination with other devices. Regardless of the design, a common requirement for many fuse applications is the provision of some form of indication that the fuse has operated. This makes finding the “blown” fuse much easier.

The most common method of indication is to run a small conductive wire in parallel with the main element(s). When the main element melts, system voltage causes current to flow through the indicator wire and to melt it. The current quickly switches back to the main elements, which then arc and interrupt the overcurrent. The melting of the indicator wire provides indication through a variety of means. Most commonly, the indicator wire is arranged to release a spring loaded pin, or ignite a small explosive charge to move a striker, when the indicator wire melts.

Another means of indication has been to connect, in parallel with the fuse, a circuit containing a light emitting device, such as a neon, LED or lamp. Again, system voltage across the indication circuit after the fuse has operated is necessary for this method to work.

U.S. Pat. No. 2,543,245 to Laing discloses a simple method of providing visual indication of a blown fuse. This patent shows a fuse having a brightly colored end cap which moves outwardly when the fuse is blown. Covering the movable end cap is an outer end cap which includes a view port through which the movable end cap is visible. When the fuse is blown the color of the end cap fills the view port providing visual indication of the blown fuse.

While such visual indication has proven beneficial, fuses are often installed in such a way that access to the visual indication means is difficult. For example, cable junctions having fused connections are often covered or encapsulated in insulating sleeves, jackets or other form of protective housing to seal the junction from the environment. Such sleeves or jackets must first be removed to gain access to the fuse hidden therein in order to visually determine if the fuse has blown.

In another common application, connections in urban medium and low-voltage underground power distribution systems, such as between cables and transformers, are generally accomplished with some form of multiple cable junction. Such multiple cable junctions typically distribute medium or low voltage from a main feeder cable to multiple cable taps, which in turn routes power to multiple users. Conventional cable junctions for this purpose, known in the field as “junction crabs,” generally consist of a unitary mass of epoxy having multiple tap branches extending therefrom and fuses for each branch integrally molded therein.

Network failures in such systems are often caused by power surges, which may result in one or more of the fuse elements within the “crab” being blown. The first problem in correcting the network failure is to find the blown fuse. With the fuse hidden from view within the crab, location of a blown fuse is difficult.

The second problem is replacement. As described above, conventional construction of multiple cable junctions is based on permanently connected fuse links. Therefore, if any one of the fuse links blows, the feeder cable feeding the junction must first be deenergized and the entire defective junction must be cut out of the circuit and a new unit spliced in. This means that the multiple users fed by the feeder cable remain out of service while the junction is replaced. Obviously, this conventional procedure results in undesirable long system outage time.

Accordingly, it would be desirable to provide a fuse having visual indication means with a sleeve that provides visual access to the fuse without having to remove or disassemble components of the cable connection employing the fuse, and wherein a blown fuse can be easily replaced without substantially disrupting service through a multiple connection.

### SUMMARY OF THE INVENTION

The present invention is a protective sleeve for a fuse connection. The protective sleeve includes an insulative sleeve body having first and second body portions adapted to provide a water-resistant seal at opposite ends of a fuse connection and a substantially transparent window disposed between the first and second body portions. The window permits a fuse of the fuse connection to be visible therethrough.

In a preferred embodiment, the window has an annular mid-section and first and second insertion ends extending in opposite directions from the mid-section. The first insertion end is disposed within the first sleeve body portion and the second insertion end is disposed within the second sleeve body portion. The first insertion end of the window can be fixed within the first sleeve body portion and the second insertion end of the window can be adapted to be slidably removable from the second sleeve body portion. Alternatively, the sleeve body can include at least one rib connecting the first and second body portions together.

Also, at least one of the first and second sleeve body portions preferably includes a radially enlarged open cuff end adapted to receive one of a cable plug end or a multiple cable junction branch. The cuff end preferably has a corrugated inner surface to enhance sealing between the cuff end and the cable plug end or the multiple cable junction branch. At the opposite end, the body portion can include a conically tapered end interface adapted to seal around an insulative jacket of a cable.

The present invention further involves a fuse connection including a fuse having first and second end terminals and a visual indicator for indicating a status of said fuse. A first electrically conductive component is electrically connected to the first end terminal of the fuse and a second electrically conductive component is electrically connected to the second end terminal of the fuse. The first and second components both include an inner conductor surrounded by an insulative jacket. A protective sleeve encapsulates the fuse and includes a first insulative body portion providing a water-resistant seal on the insulative jacket of the first component and a second insulative body portion providing a water-resistant seal on the insulative jacket of the second component. The sleeve further includes a substantially transparent window disposed between the first and second sleeve body portions, wherein the visual indicator is visible through the window.

The present invention also involves a multiple fused junction. The junction includes a main body having multiple cable ports extending outwardly therefrom and each of the cable ports includes an internal conductor surrounded by an insulative jacket. The junction further includes a fuse electrically connected at one of the cable ports. The fuse has a visual indicator for indicating a status of the fuse, a first end terminal electrically connected to the internal conductor of the cable port and a second end terminal. A cable having an internal conductor surrounded by an insulative jacket is electrically connected to the fuse and a protective sleeve encapsulates the fuse. The sleeve includes a first insulative body portion providing a water-resistant seal on the cable port insulative jacket, a second insulative body portion providing a water-resistant seal on the cable insulative jacket and a substantially transparent window disposed between the first and second sleeve body portions, wherein the visual indicator of the fuse is visible through the window.

A preferred form of the multiple fused junction with blown fuse indication, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is a top view of a fused cable connection showing a color indicator fuse in a closed or live state.

FIG. 2 is a cross-sectional view of the fused connection shown in FIG. 1.

FIG. 2A is an isolated side view of the outer surface of the cup shown in FIG. 2.

FIG. 3 is a cross-sectional view of the fused connection shown in FIGS. 1 and 2 showing the fuse in an open or blown state.

FIG. 4 is a top view of the fused connection shown in FIG. 3.

FIG. 5 is a cross-sectional view of a fuse sleeve formed in accordance with the present invention.

FIG. 6 is a side view of the fuse sleeve shown in FIG. 5, wherein the fuse is showing an open or blown condition.

FIG. 7 is a cross-sectional view of an alternative embodiment of a fuse sleeve formed in accordance with the present invention showing a first body portion of the sleeve slipped off the window.

FIG. 8 is a cross-sectional view of the fuse sleeve of FIG. 7 showing the first body portion of the sleeve slipped on the window.

FIG. 9 is a plan view of a multiple cable junction having fuse sleeves of the present invention provided at each branch of the junction.

### DETAILED DESCRIPTION OF ILLUSTRATIVE EMBODIMENTS

Referring first to FIGS. 1-4, a fused connection 10 with which the present invention is used is shown. The fused connection 10 generally includes a power cable 12, a color indicator fuse 14 and a connection terminal 16. The connection terminal 16 may simply be a terminal portion of another cable, or, as will be discussed in further detail below, the connection terminal may be part of a multiple fused cable junction, known in the field as a “crab.”

The cable 12 may be provided with a copper spade crimp connector 13 at its connection end, which is connected to a second end terminal 32 of the fuse 14. In this regard, the end terminal 32 may include a copper tang portion 15 having threaded holes to permit attachment of the cable 12 to the fuse 14 with bolts 17 or other fasteners. Similarly, at its opposite end, the fuse 14 may include a first end terminal 28 provided with a copper spade portion 19, which is connectable to a conductive tang 21 of the connection terminal with bolts 17.

The fuse 14 used in the present invention is adapted to provide visual indication when the fuse is blown. In this regard, the fuse 14 may include a spring loaded indicator cup 18 slidably received within a bore 20 of the fuse. The cup 18 may include a shoulder portion 22 disposed within the fuse bore 20, which is biased by a spring 24. A fusible element 26 is fixed between the shoulder portion 22 and a first end terminal 28 of the fuse 14. A conductive flexible connection 30 is connected between the shoulder portion 22 and an opposite second end terminal 32 of the fuse 14, thereby completing an electrical path between the first and second end terminals.

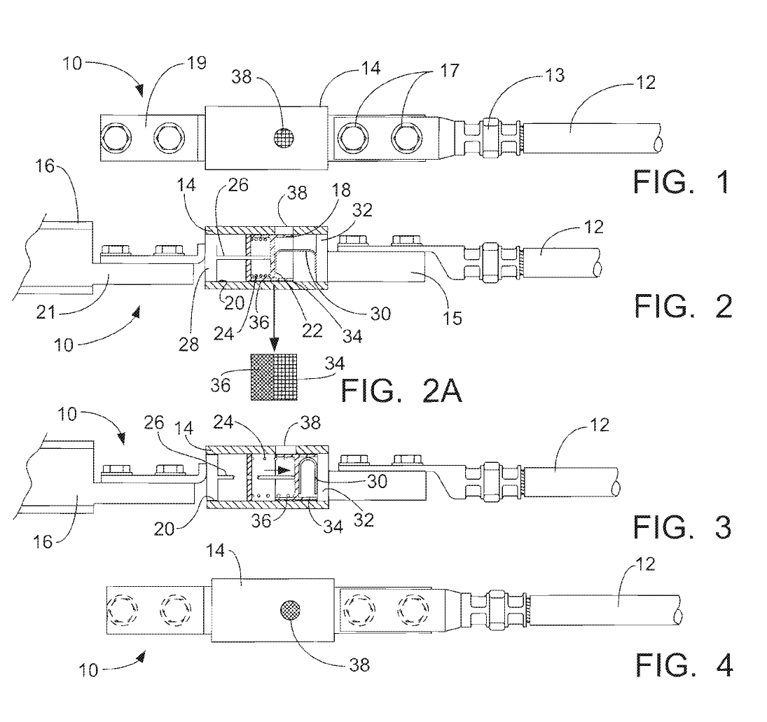

To provide visual indication of the condition of the fuse 14, the slidable cup 18 is provided with contrasting color portions. For example, the outer surface of the forward portion 34 of the cup 18 may be colored red, while the outer surface of a rearward portion 36 of the cup may be colored green, as shown in FIG. 2A. The fuse 14 may include an aperture 38, termed a “viewing port,” formed through the fuse body adjacent the cup 18 which allows an observer to see the outer surface of the cup. The aperture is typically covered with a sight glass or other transparent protective member, but may also be left open.

As shown in FIGS. 1 and 2, in its normal operating state, wherein current flows between the fuse terminals 28 and 32, the forward red portion 34 of the cup 18 is visible through the viewing port 38. However, once the fusible element 26 melts due to an over-current condition, the loaded spring 24 will move the cup 18 forward away from the first end terminal 28 toward the second end terminal 32, as shown in FIGS. 3 and 4. This in turn moves the green rearward portion 36 of the cup 18 to the viewing port 38 to be visible therethrough. The color green viewed through the viewing port 38 now indicated an open or blown fuse 14.

As will be appreciated by one skilled in the art, the fuse 14 described above is but one example of a fuse suitable for use with the present invention. Other mechanically driven visual indicator fuses are known in the art and may also be used with the present invention. One such fuse is described, for example, in U.S. Pat. No. 2,543,245.

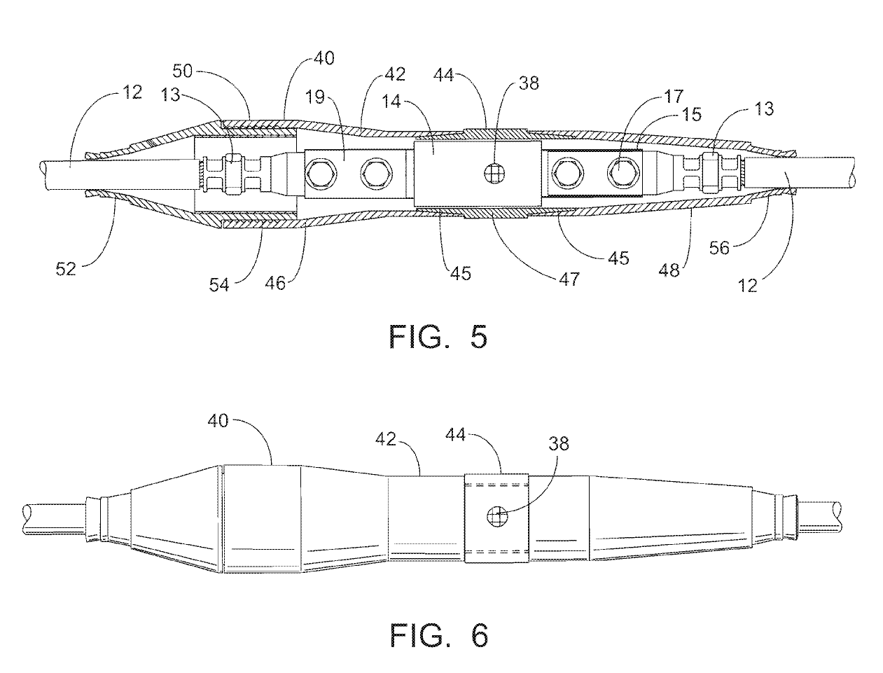

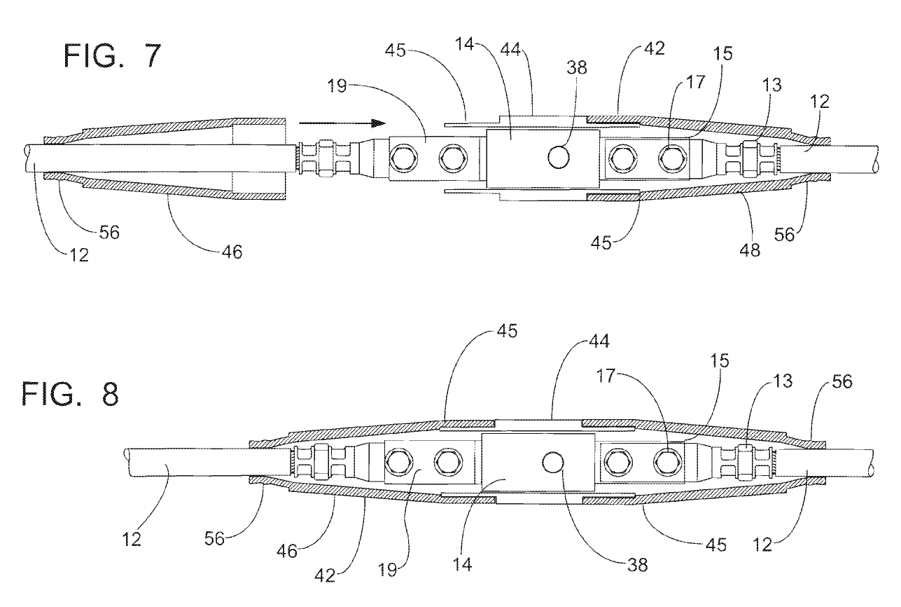

Turning now to FIGS. 5 and 6, the present invention is shown incorporating a fuse sleeve 40 which allows the condition of the color indicator fuse 14 to be visible therethrough. The sleeve 40 includes a tubular body 42 and a transparent window 44 fixed therein. The body 42 is made from a resilient insulative material having good water-resistant sealing properties, such as rubber. The body 42 may include two body portions 46 and 48 with the window 44 fixed therebetween, as shown in FIGS. 5 and 6, or the body may be a unitary member having ribs, for example, connecting portions on opposite sides of the window, not shown. The first body portion 46 may be formed with a cuff portion 50, which is adapted to receive an insulative plug end 52 of a cable 12. In this embodiment, the cuff end 50 may include a corrugated inner surface 54 to enhance sealing between the sleeve 40 and the cable plug 52. The second body portion 48 may be formed with a tapered end interface 56 adapted to seal directly around the cable itself. As will be discussed in further detail below with reference to FIGS. 7 and 8, one skilled in the art will appreciate that various combinations of cuffs 50 and tapered ends 56 can be utilized in the sleeve of the present invention depending on the particular installation.

In any event, the window 44 is made from a durable transparent material, such as plexiglass, and is preferably integrally molded together with the body 40. The window 44 is preferably in the form of a cylindrical tube having insertion ends 45 extending in opposite directions from a central mid-section 47. The insertion ends 45 are preferably conically tapered and are sized for respective insertion into the first and second body portions 46 and 48 of the sleeve body 42. A bonding agent may be utilized between the insertion ends 45 and the body 40 to enhance sealing therebetween.

The mid-section 47 of the window 44 is left uncovered by the sleeve body 42 so as to provide an annular window to the sleeve. When the sleeve 40 is assembled around the fuse 14, the annular mid-section 47 of the window 44 is longitudinally aligned with the viewing port 3 8 of the fuse 14. This forms a window in the form of a ring, which allows the viewing port 38 of the fuse 14 to be visible through the mid-section 47 of the window regardless of the radial position of the fuse within the sleeve 40.

Turning now to FIGS. 7 and 8, in an alternative embodiment, the first and/or second body portions 46 and 48 of the sleeve body 42 can be adapted to be slipped over the insertion ends 45 of the window 44 upon assembly or in the field to form a water-tight seal therebetween. In this embodiment, the window 44 can be fixed to the first body portion 46, the second body portion 48 or neither body portion. It is also conceivable for the window 44 to be fixed directly to the fuse 14. In this embodiment, replacement of the fuse 14 can be easily achieved by sliding the first and/or second body portion 46/48 off the insertion end(s) 45 of the window 44. FIGS. 7 and 8 also shows an alternative embodiment, wherein both the first and second body portions 46, 48 have tapered end interfaces 56 adapted to seal directly around a cable itself

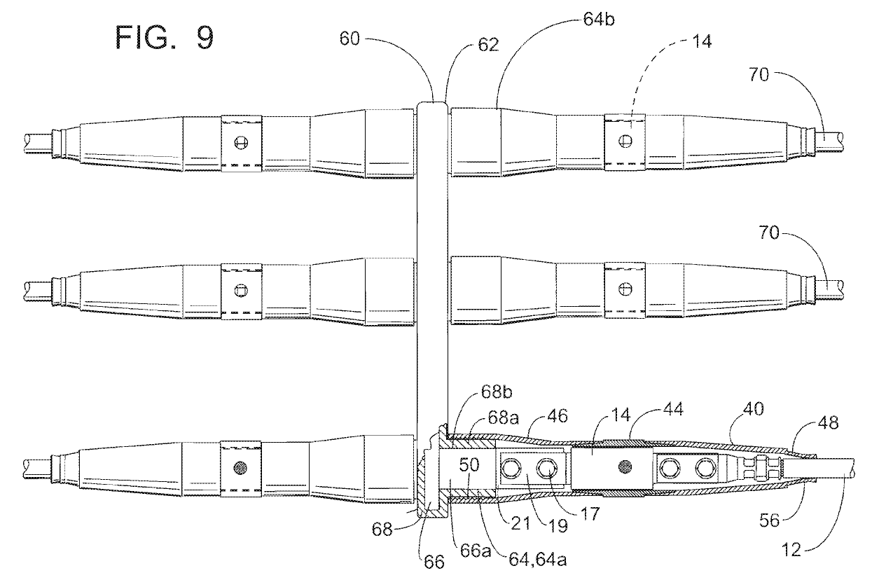

As mentioned above, the present invention is particularly well suited for use with multiple fused cable junction installations, as shown in FIG. 9. The multiple fused junction 60 shown in FIG. 9 is known in the art as a crab. The junction 60 generally includes a main body 62 having multiple cable ports 64 extending outwardly therefrom. The main body 62 preferably includes an internal conductive shell 66 encapsulated within an insulative outer jacket 68, such as rubber or plastic. The internal conductive shell 66 is made from an electrically conductive material, such as copper, and is adapted to conduct electricity between the multiple cable ports 64 of the main body 62. The insulative jacket 68 provides electrical insulation and a watertight seal to the main body 62 and is preferably rated to 600 volts.

The junction 60 may include any number of closely spaced ports 64 extending from both sides. In a preferred embodiment, the junction 60 has 3, 5 or 7 ports 64 protruding from each side, representing a three-way, five-way, or seven-way cable limiter. The ports 64 may be made by forming protruding boss portions 68a of the insulative jacket 68 so that the insulative jacket takes the form of a tree having multiple branches extending outwardly from a central trunk portion. Each of the boss portions 68a is tubular in shape and includes an internal bore 68b to permit access to the internal conductive shell 66. Alternatively, or in addition to, the conductive shell 66 may include protruding branch sections 66a, which are received in the internal bores 68b of the insulative jacket 68 to form part of the ports 64.

In any case, one of the ports 64a on each side of the main body 62 is adapted for connection with a feeder cable, which feeds power to the junction from the utility system network. The feeder cable may be electrically connected directly to the junction 60 or connected via a fused connection. As described above, the feeder cable 12 can be attached to a color indicator fuse 14 through the use of a crimp connector 13 or other solid disconnectable element. On its opposite end, the fuse can be electrically and mechanically connected to the conductive shell 66 via a conductive spade 19 and tang 21 arrangement fastened together with bolts 17.

In this case, the entire fused connection is sheathed within the fuse sleeve 40 of the present invention. Specifically, the tapered end interface 56 of the second body portion 48 is adapted to seal directly against the outerjacket of the feeder cable 12, while the cuff portion 50 of the first body portion is adapted to engulf the protruding boss portion 68a of the insulative jacket 68 of the junction 60. In this regard, the end interface 56 of the second body portion 48 is preferably designed to extend in the feeder cable direction to slip over a sufficient length of the outer surface of the feeder cable 12 and, in the opposite direction, the cuff 50 is designed to extend a sufficient length to substantially slip over the entire protruding boss portion 68a of the insulative jacket 68 forming the feeder branch 64. Thus, the fuse sleeve 40 of the present invention provides a water-tight and contaminant-free seal between the feeder cable 12 and the junction 60.

The remaining ports 64b of the main body 62 are designated as tap branches and are adapted to distribute power from the feeder cable 12 to multiple tap cables 70. Each of the tap cables 70 is preferably connected to the crab 60 in a manner similar to that described above. In particular, each tap cable 70 is connected to a color indicator fuse 14, which in turn is connected to the internal conductive shell 66 of the junction 60 and each fused connection is encapsulated by a fuse sleeve 40 of the present invention.

As a result of the present invention a multi-cable junction is provided with insulative protective fuse sleeves, which allows for simple and easy determination of the status of multiple fuses, without having to remove the sleeves or disassemble the junction. Thus, a blown fuse can be easily detected and replaced without having to replace the whole unit. This saves money and time. Only the leg that has the blown fuse needs to be serviced, unlike the “crab” system presently used, where all the legs of the crab have to be removed and reconnected. This fuse replacement feature can reduce down time to hours versus days.

Moreover, the present invention provides a junction which distributes low or medium voltage power from a main feeder cable to multiple cable taps (4, 8 or 12), wherein each of the cable taps is provided with a fuse and each fuse is protected by a fuse sleeve for electrical insulation and water submersion capability. When a fuse blows due to over-current, the window of the fuse sleeve provides easy visibility to the fuse. This allows for rapid location for replacement of the blown fuse.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A protective sleeve for a fuse connection comprising:
an insulative sleeve body including first and second body portions adapted to provide a water-resistant seal at opposite ends of a fuse connection; and
a substantially transparent window disposed between said first and second body portions, said window permitting a fuse of the fuse connection to be visible therethrough.

2. A protective sleeve as defined in claim 1, wherein said window comprises an annular mid-section and first and second insertion ends extending in opposite directions from said annular mid-section, said first insertion end being disposed within said first sleeve body portion and said second insertion end being disposed within said second sleeve body portion.

3. A protective sleeve as defined in claim 2, wherein said first insertion end of said window is fixed within said first sleeve body portion and said second insertion end of said window is slidably removable from said second sleeve body portion.

4. A protective sleeve as defined in claim 1, wherein said sleeve body further includes at least one rib connecting said first and second body portions.

5. A protective sleeve as defined in claim 1, wherein at least one of said first and second sleeve body portions includes a radially enlarged open cuff end adapted to receive one of a cable plug end or a multiple cable junction branch.

6. A protective sleeve as defined in claim 5, wherein said cuff end has a corrugated inner surface to enhance sealing between said cuff end and the cable plug end or the multiple cable junction branch.

7. A protective sleeve as defined in claim 1, wherein at least one of said first and second sleeve body portions comprises a conically tapered end interface adapted to seal around an insulative jacket of a cable.

8. A fuse connection comprising:
a fuse having first and second end terminals and a visual indicator for indicating a status of said fuse;
a first electrically conductive component electrically connected to said first end terminal of said fuse, said first component including an inner conductor surrounded by an insulative jacket;
a second electrically conductive component electrically connected to said second end terminal of said fuse, said second component including an inner conductor surrounded by an insulative jacket; and
a protective sleeve encapsulating at least a portion of said fuse, said sleeve including a first insulative body portion providing a water-resistant seal on said insulative jacket of said first component, a second insulative body portion providing a water-resistant seal on said insulative jacket of said second component and a substantially transparent window disposed between said first and second sleeve body portions, wherein said visual indicator of said fuse is visible through said window.

9. A fuse connection as defined in claim 8, wherein said window of said protective sleeve comprises an annular mid-section and first and second insertion ends extending in opposite directions from said annular mid-section, said first insertion end being disposed within said first sleeve body portion and said second insertion end being disposed within said second sleeve body portion.

10. A fuse connection as defined in claim 9, wherein said first insertion end of said window is fixed within said first sleeve body portion and said second insertion end of said window is slidably removable from said second sleeve body portion.

11. A fuse connection as defined in claim 8, wherein said sleeve further includes at least one rib connecting said first and second body portions.

12. A fuse connection as defined in claim 8, wherein at least one of said first and second sleeve body portions includes a radially enlarged open cuff end adapted to receive one of a cable plug end or a multiple cable junction branch of said first or second electrically conductive component.

13. A fuse connection as defined in claim 12, wherein said cuff end has a corrugated inner surface to enhance sealing between said cuff end and the cable plug end or the multiple cable junction branch.

14. A fuse connection as defined in claim 8, wherein at least one of said first and second sleeve body portions comprises a conically tapered end interface adapted to seal around an insulative jacket of said first or second electrically conductive component.

15. A multiple fused cable junction comprising:
a main body having multiple cable ports extending outwardly therefrom, each of said cable ports including an internal conductor surrounded by an insulative jacket;
a fuse electrically connected at one of said cable ports, said fuse having a visual indicator for indicating a status of said fuse, a first end terminal electrically connected to said internal conductor of said cable port and a second end terminal;
a cable electrically connected to said fuse, said cable including an internal conductor electrically connected to said second end terminal of said fuse and an insulative jacket surrounding said internal conductor; and
a protective sleeve encapsulating said fuse, said sleeve including a first insulative body portion providing a water-resistant seal on said cable port insulative jacket, a second insulative body portion providing a water-resistant seal on said cable insulative jacket and a substantially transparent window disposed between said first and second sleeve body portions, wherein said visual indicator of said fuse is visible through said window.

16. A junction as defined in claim 15, wherein said window of said protective sleeve comprises an annular mid-section and first and second insertion ends extending in opposite directions from said annular mid-section, said first insertion end being disposed within said first sleeve body portion and said second insertion end being disposed within said second sleeve body portion.

17. A junction as defined in claim 16, wherein said first insertion end of said window is fixed within said first sleeve body portion and said second insertion end of said window is slidably removable from said second sleeve body portion.

18. A junction as defined in claim 15, wherein at least one of said first and second sleeve body portions includes a radially enlarged open cuff end adapted to receive one of a cable plug end of said cable or said cable port of said main body.

19. A junction as defined in claim 18, wherein said cuff end has a corrugated inner surface to enhance sealing between said cuff end and the cable plug end or the cable port.

20. A junction as defined in claim 15, wherein said second sleeve body portion comprises a conically tapered end interface adapted to seal around said cable jacket.
